(19) United States
(12) Patent Application Publication
(10) Pub. No.: US 2002/0139155 A1
(43) Pub. Date: Oct. 3, 2002

(54) Closure equipped with a combination lock

(76) Inventor: Eberhard Franzen, Solingen (DE)

Correspondence Address: Martin A. Farber, (Suite 473), 866 United Nations Plaza, New York, NY, 10017, US

(21) Appl. No.: 10/005,474

(22) Filed: Nov. 7, 2001

(30) Foreign Application Priority Data
Nov. 17, 2000 (DE) 100 57 133.6

(51) Int. Cl. E05B 13/10

(52) U.S. Cl. 70/213; 70/215; 70/284; 70/285

(57) ABSTRACT

Closure (1) which is equipped with a combination lock (2) and, when a secret code is set correctly, can be opened, a catch member (21) of a first closure part (3), in a locking position, being positioned in a catch inlet opening (25) of a second closure part (4), from which opening the catch member having been moved out when it is in an open position. In addition, the catch member (21) can be lifted out of the catch inlet opening (25) by actuation of a lock cylinder (27).

The invention relates to a closure which is equipped with a combination lock and, when the secret code is set correctly, can be opened, a catch member of a first closure part, in the locking position, being positioned in a catch inlet opening of a second closure part, from which opening the catch member has been moved in when it is in the open position.

Such closures are known and have many uses. For example, they can be used even in the case of cabinets which serve as storage compartments in public establishments. Since the secret code set is forgotten again and again, it has to be possible for the cabinet to be opened by a supervisor.

It is the object of the invention to configure a closure of the type in question in a straightforward manner in production terms such that, when the secret code is set and its catch member assumes its locking position, the closure can easily be opened, for example, by a supervisor.

This object is achieved first and foremost in the case of a closure having the features of claim 1, this being based on the fact that, in addition, the catch member can be lifted out of the catch inlet opening by actuation of a lock cylinder.

Such a configuration provides a closure which is equipped with a combination lock and has increased use value. The closure is normally opened and closed with the aid of the combination lock, to be precise including the number discs associated with the combination lock. If, in the case of such closures being used in storage compartments or cabinets, the user has forgotten the secret code, then he/she can turn to a supervisor who, by means of a key belonging to the lock cylinder, can lift the catch member out of the catch inlet opening, whereupon the closure can be opened. This is possible because the locking of the first closure part in relation to the second closure part has been eliminated and the first closure part can be displaced in relation to the second closure part, this resulting in the cabinet door or the door of the storage compartment being opened. It is also possible for a supervisor, if required, to open and reclose, for monitoring purposes, all the storage compartments or cabinets belonging to an establishment. In detail, the closure is constructed such that the catch member, which is spring-loaded in the direction of its open position, is acted upon by a rocker which can yield counter to spring force and belongs to the combination lock. Accordingly, both the rocker of the combination lock and also the lock cylinder act on the catch member. This makes it possible for the number of lock components to be reduced and for the closure to be produced and offered for sale cost-effectively. The invention also provides that the catch member is displaced into its open position in a cam-regulated manner by the lock cylinder. The turning to lock the lock cylinder is accordingly used to lift the catch member out of the catch inlet opening. This advantageously takes place in that the cam associated with the lock cylinder is a rotary wedge. The latter is the component which moves the catch member out of the catch inlet opening. The moving-out operation is aided in that the rotary wedge acts on a regulating shoulder of the catch member. This fact likewise has a wear-reducing effect. In order, when the closure is open, despite the catch member being locked in a forward position, to allow the closure to be closed, the catch member first of all yields in a latch-like manner in order, when aligned with the catch inlet opening, to enter into the latter. It should also be emphasized that the catch member is a pivoting catch. On the one hand, it is supported on the rocker, which follows the position of the blocking sleeves. On the other hand, it interacts with the rotary wedge. The procedure here is such that the rocker is associated centrally with the blocking sleeves of the combination lock. Accordingly, the rocker can be pivoted in both directions. A user-friendly configuration is realized in that the axis of the lock cylinder is disposed such that it crosses the axis of the number discs. It is also provided that the two closure parts can be rotated in relation to one another for opening purposes. Conversely, this means that the closure parts have to be rotated back for closing purposes. If appropriate, it is possible to feel the corresponding rotary positions of the closure parts as a result of snap-in elements. Finally, it should also be emphasized that the regulation shoulder is disposed at the free end of the catch member. This is associated with favourable leverages for moving the catch member out of its position within the catch inlet opening.

An exemplary embodiment of the invention is explained hereinbelow with reference to the drawings, in which:

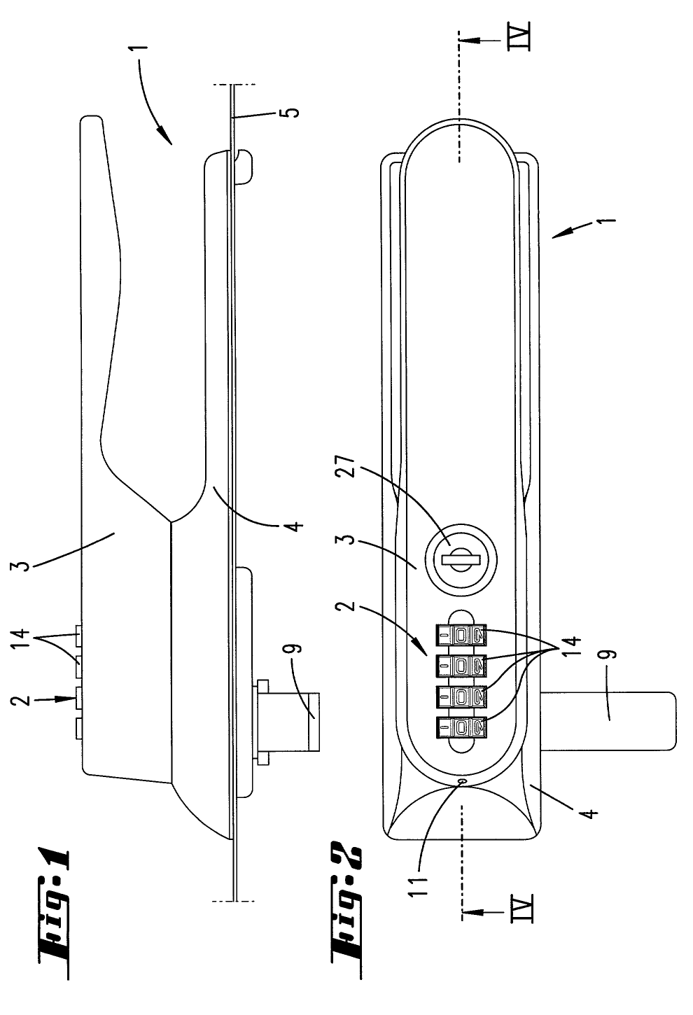

FIG. 1 shows a view of the closure assuming its closure position,

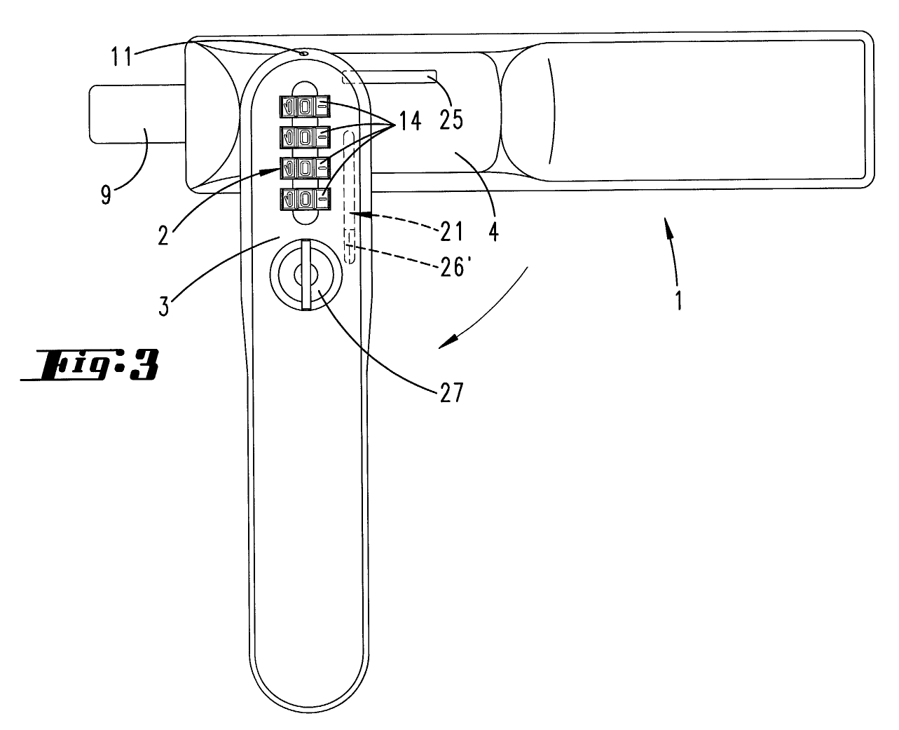

FIG. 2 shows a plan view of the closure,

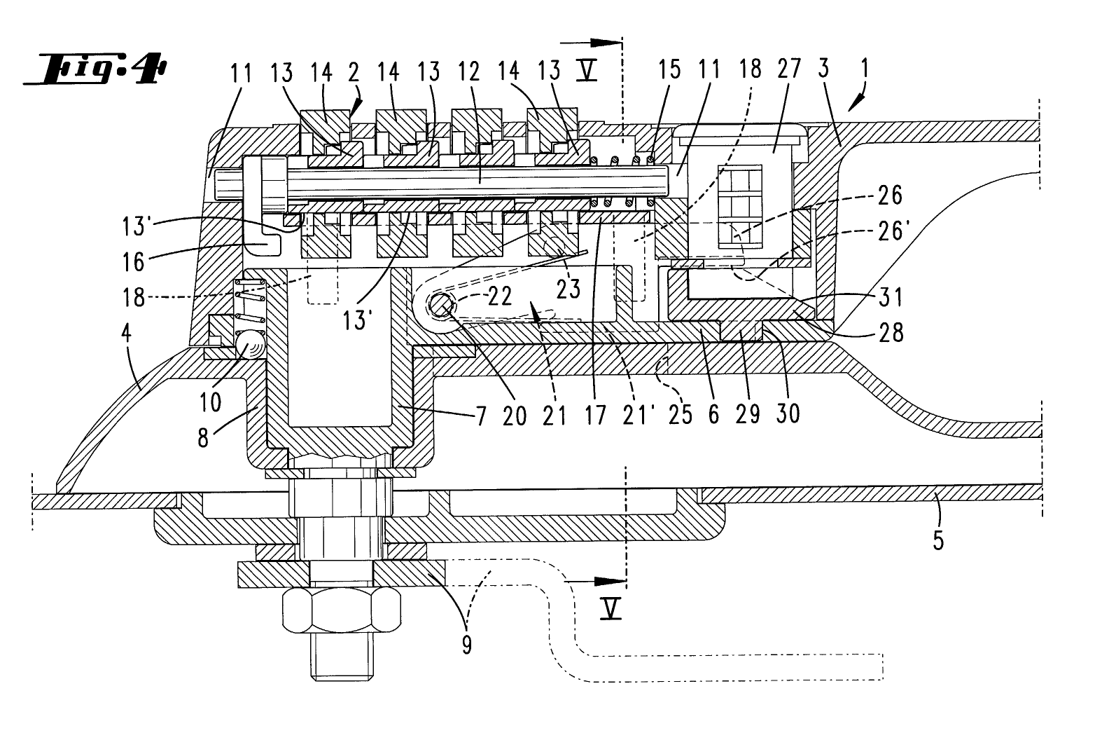

FIG. 3 shows an illustration which is comparable with FIG. 2 but with the first closure part rotated into the open position,

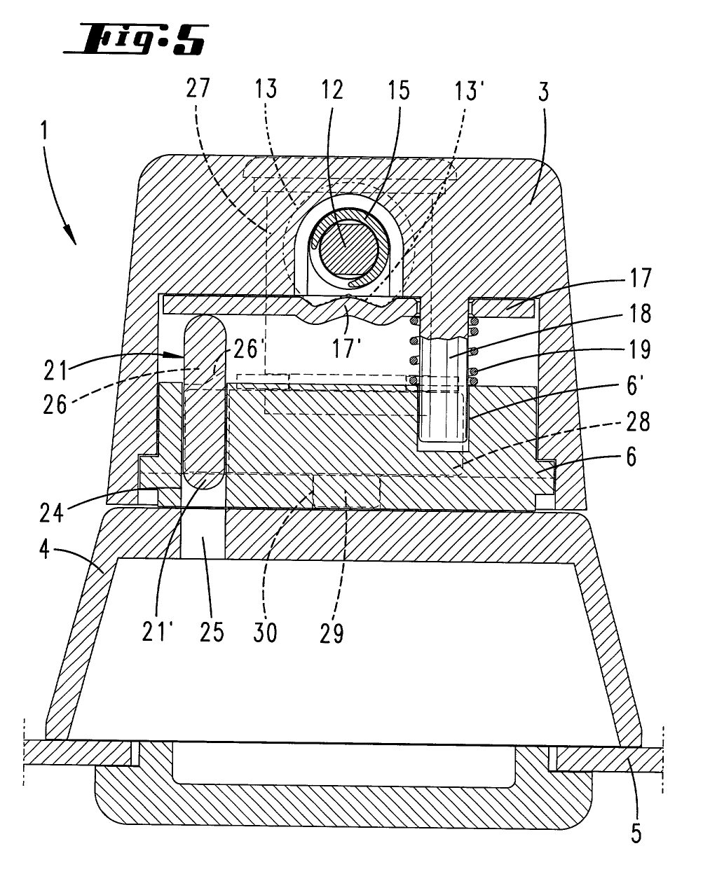

FIG. 4 shows the section along line IV-IV in FIG. 2,

FIG. 5 shows the section along line V-V in FIG. 4,

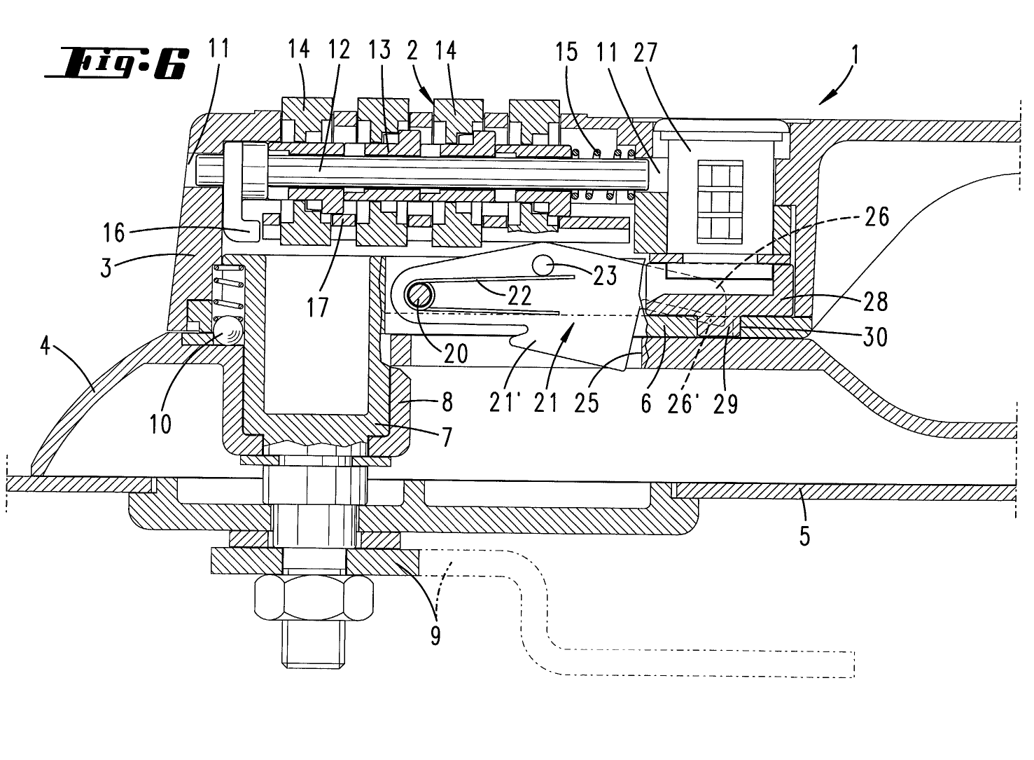

FIG. 6 shows an illustration which is comparable to FIG. 4 but with the secret code adjusted and the catch member in the locking position,

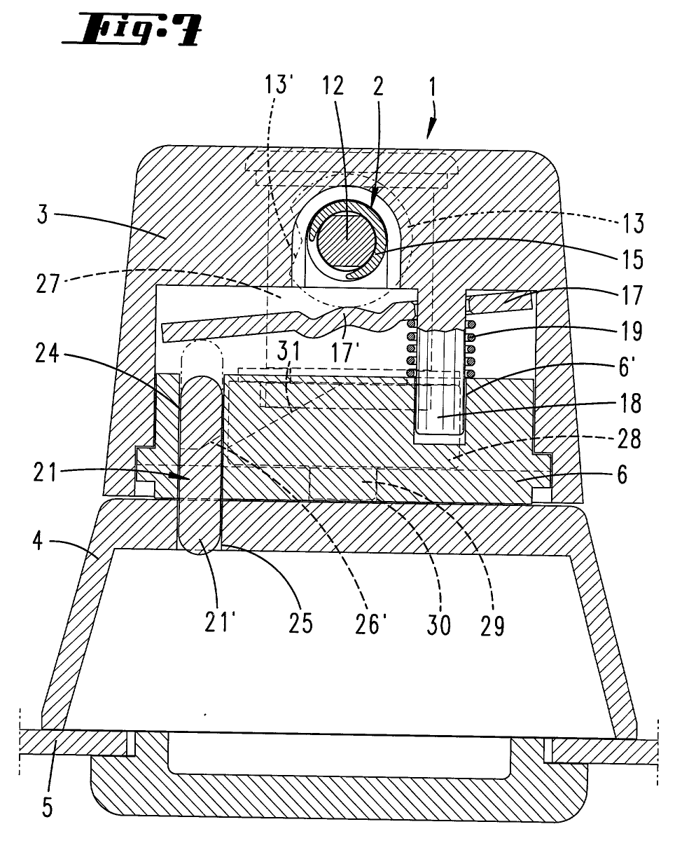

FIG. 7 shows a section comparable to FIG. 5, the catch member being in the engagement position,

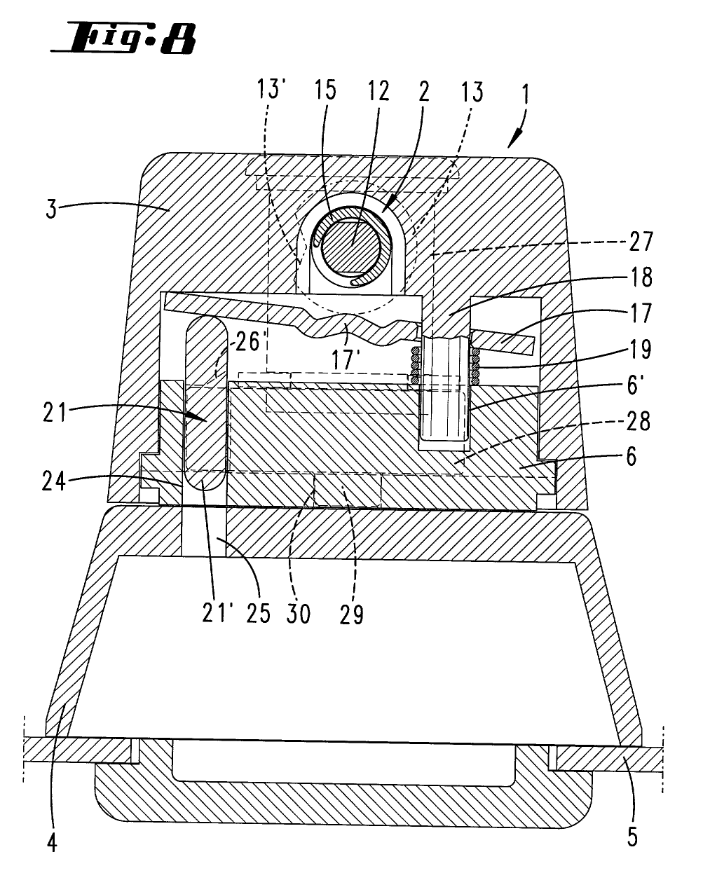

FIG. 8 shows a cross section through the closure comparable to FIG. 7, to be precise with the catch member lifted out by the lock cylinder,

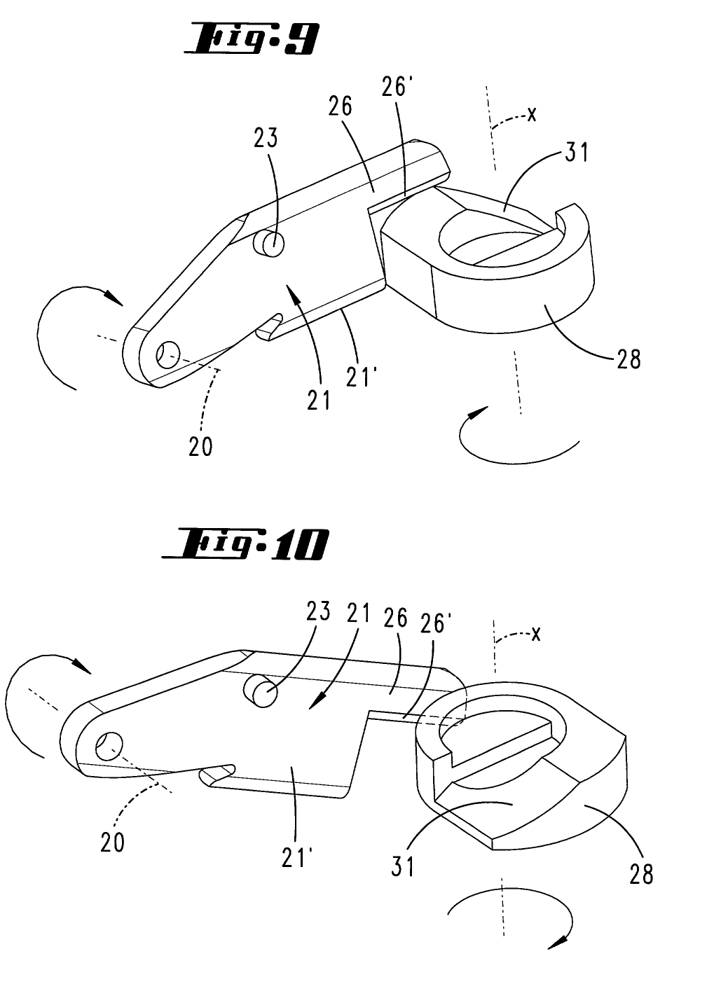

FIG. 9 shows a perspective illustration solely of the catch member and the rotary wedge, both components assuming the position according to FIG. 4, and

FIG. 10 shows, likewise in a perspective illustration, the catch member and the closing wedge corresponding to FIG. 6, from which the rotary wedge, upon closing actuation, passes into a position in which the catch member is lifted out.

The closure is designated as a whole by the numeral 1. It has a first closure part 3, which accommodates a combination lock 2, and a second closure part 4, over which the first closure part 3 can grip. In the exemplary embodiment, this closure part 4 is secured on a cabinet door 5.

The first closure part 3 is configured in the form of a pivotable handle. For this purpose, the base 6 of the first closure part 3 forms an integral rotary stub 7 which is seated in a bearing shell 8 of the second closure part 4 and carries a pivoting catch 9 at one end for interaction with a mating closure part (not illustrated) of the relevant cabinet or storage compartment. A snap-in ball 10 is provided, so that it is possible to feel the closure or open position of the first closure part 3.

The first closure part 3, which is closed by the base 6, carries in a bearing opening 11 in its interior a pin 12, on which blocking sleeves 13 are located in a row one behind the other. Four such blocking sleeves 13 are provided. In each case one number disc 14 is provided concentrically with each blocking sleeve 13, releasable coupling engagement taking place between each blocking sleeve 13 and number disc 14. The number discs 14 are provided with numbers on their periphery. Furthermore, the number discs 14 have part of their periphery engaging through corresponding recesses of the first closure part 3. The number discs 14, which can be seen from the outside in each case and are located in a row, can embody the secret code set, by means of which it is possible to transfer the closure 1 into the open position.

The blocking sleeves 13 are coupled positively, in known manner, to the number discs 14. A number of coupling positions which corresponds to the number of numbers on each number disc is possible. In order to change the secret codes set, it is necessary to displace the pin 12 axially, to be precise counter to the force of a compression spring 15, which loads the blocking sleeves 13 into engagement and is disposed on the pin 12. This displacement, however, can only be carried out when the correct secret code has been set. For this purpose, the pin 12 is associated with a radially projecting arm 16 which, when the secret code is set correctly, can move under a rocker 17. The axial displacement of the pin 12 causes the blocking sleeves 13 to be carried along as well, the sleeves passing out of their coupling engagement with the number discs 14. Accordingly, the latter may be rotated and thus allow a new secret code to be selected. This is fixed when the pin 12 is displaced back again, as are, accordingly, the blocking sleeves 13.

Each blocking sleeve 13 is provided with a concavely extending flattened portion 13′, which interacts with a correspondingly convex section of the rocker 17. The convex section 17′ against the rocker 17 extends centrally under the pin 12, according to the drawings. The rocker 17 is mounted about two upright stubs 18 of the first closure part 1. A compression spring 19 is disposed on each upright stub 18, as a result of which the rocker 17 is loaded in the direction of a position in which it butts against the blocking sleeves 13. The abovementioned upright stubs 18 extend in a decentralized manner in relation to the pin 12. The free ends of the upright stubs 18 engage in corresponding bores 6′ of the base 6. Accordingly, the upper side of the base provides the compression springs 19 with their support opposite the rocker 17.

In the region under the second and third number disc 14, the base 6 carries a transverse stub 20. A single-armed catch member 21 can be pivoted about the latter. The transverse stub 20 carries a leg spring 22, which acts on a stub-like protrusion 23 of the catch member 21 and spring-loads the latter in the direction of abutment against the rocker 17. In order to accommodate the catch member 21, the base 6 forms a channel 24 running in the longitudinal direction of the first closure part 3. A catch inlet opening 25 of the second closure part 4 is aligned with this channel 24 in the closed position of the closure 1. The catch member 21 is thus forced by spring action counter to its engagement direction. At the free end, the catch member 21 has a step-like formation and thus provides an extension portion 26 on the upper side. This extension portion defines, on the underside, a regulating shoulder 26′ which slopes up obliquely in relation to the displacement plane of the catch member 21 and is intended for interacting with a lock cylinder 27 of the first closure part 3, the lock cylinder being disposed on the far side of the pin 12. The lock-cylinder axis x here is disposed such that it crosses the pin 12 of the number discs 14. The inner end of the lock cylinder 27 is coupled positively to a rotary wedge 28. A bearing journal 29, which is disposed coaxially with the lock cylinder 27, engages in a bearing recess 30 of the base 6. The rotary wedge 28, which is of elongate configuration in plan view, forms an upwardly sloping cam 31, into the turning circle of which the regulating shoulder 26′ of the catch member 21 projects. Provision is made for it to be possible, by means of a key (not illustrated), for the lock cylinder 27 to be rotated through 180° and thus for the rotary wedge 28 to be rotated to this extent.

Functioning is as follows:

According to FIGS. 1, 2, 4 and 5, the closure 1 is in a state in which the intended secret code has been set on the combination lock and the lock cylinder 27 has rotated the rotary wedge 28 into the open position. On account of the secret code being set correctly, the blocking sleeves 13 have been rotated such that the flattened portions 13′ are located in a line and allow the rocker 17 to be pivoted up into the position according to FIGS. 4 and 5. On account of this, it is also possible for the catch member 21 to be pivoted into its position according to 4 and 5, the catch member having its lower flank 21′, which is configured in the manner of a latch, located above the second closure part 4 and thus above the catch inlet opening 25. This means that the closure part 3, which is configured as a handle, can pivot about its rotary stub 7 into the position according to FIG. 3, in which case the pivoting catch 9 is carried along with it, which then allows the cabinet door 5 to be opened. The catch member 21 and the rotary wedge 28 here assume a position like that which is also illustrated in FIG. 9. FIG. 5 likewise shows that the rotary wedge 28 has a radially projecting section located under the crosspiece 26 and prevents the catch member 21 from transferring into the locking position, even if the secret code is adjusted.

In order for it to be possible to realize the locking position of the closure 1, the lock cylinder 27, accordingly, can be rotated back through 180° by means of the associated key, to be precise into the position according to FIGS. 6 and 10. The secret code can then be adjusted, to be precise by means of the number discs 14, which, for their part, rotate the blocking sleeves 13 such that the rocker 17 is inevitably displaced. The rocker 17 here forces the catch member 21 to pivot into the position illustrated in FIGS. 6 and 7, to be precise such that the flank 21′ engages in the catch inlet opening 25 of the second closure part 4.

If the lock cylinder 27 is actuated and the secret code is adjusted when the first closure part 3 has been pivoted, then this results in the catch member 21 projecting beyond the lower surface of the base 6 by way of its flank 21′. On account of the then inclined alignment of the flank 21′, as is shown in FIG. 6, it is nevertheless possible for the first closure part 3 to be moved into a position congruent with the second closure part 4, the flank 21′ running onto the border edge of the second closure part 4 and then, accordingly, being moved back in a latch-like manner. As soon as the catch member 21 and the catch inlet opening 25 are aligned, the catch member 21 is moved, by the force of the rocker compression spring 19, into its catch projecting position. This means that the force of the compression springs 19 is greater than that of the leg spring 22.

It is possible for the cabinet door to be opened, for example, by a supervisor without the secret code being known. For this purpose, the key is used to rotate the lock cylinder 27, as is illustrated in FIG. 10, in the arrow direction. This causes the cam 31 of the rotary wedge 28 to act on the regulating shoulder 26′ of the catch member 21 and to pivot the latter. In this case, the spine of the catch member 21 acts on the rocker 1, which is supported on the periphery of one or more blocking sleeves 13 and, accordingly, assumes the position according to FIG. 8. This is maintained by the radially projecting region of the rotary wedge 28, which is disposed in front of the cam 31.

It goes without saying that, in the locked position, the user of the storage compartment adjusts the secret code in order to prevent unauthorized access to the interior of the compartment.

Since the lock cylinder has lifted the catch member 21 out, and the storage compartment has been opened and closed, by key actuation, the supervisor has to rotate the lock cylinder back again. It is only this which allows the combination lock 2 to be used as intended again.

All features disclosed are (in themselves) pertinent to the invention. The disclosure content of the associated/attached priority documents (copy of the prior application) is hereby also included in full in the disclosure of the application, also for the purpose of incorporating features of these documents in claims of the present application.

1. Closure (1) which is equipped with a combination lock (2) and, when the secret code is set correctly, can be opened, a catch member (21) of a first closure part (3), in the locking position, being positioned in a catch inlet opening (25) of a second closure part (4), from which opening the catch member has been moved out when it is in the open position, characterized in that, in addition, the catch member (21) can be lifted out of the catch inlet opening (25) by actuation of a lock cylinder (27).

2. Closure according to claim 1 or in particular according thereto, characterized in that the catch member (21), which is spring-loaded in the direction of its open position, is acted upon by a rocker (17) which can yield counter to spring force and belongs to the combination lock (2).

3. Closure according to one or more of the preceding claims or in particular according thereto, characterized in that the catch member (21) is displaced into its open position in a cam-regulated manner by the lock cylinder (27).

4. Closure according to one or more of the preceding claims or in particular according thereto, characterized in that the cam (31) associated with the lock cylinder (27) is a rotary wedge (28).

5. Closure according to one or more of the preceding claims or in particular according thereto, characterized in that the rotary wedge (28) acts on a regulation shoulder (26′) of the catch member (21).

6. Closure according to one or more of the preceding claims or in particular according thereto, characterized in that the catch member (21), which is locked in a forward position when the closure (1) is open, yields in a latch-like manner as the closure (1) is closed, in order, when aligned with the catch inlet opening (25), to enter into the latter.

7. Closure according to one or more of the preceding claims or in particular according thereto, characterized in that the catch member (21) is a pivoting catch.

8. Closure according to one or more of the preceding claims or in particular according thereto, characterized in that the rocker (17) is associated centrally with the blocking sleeves (13) of the combination lock (2).

9. Closure according to one or more of the preceding claims or in particular according thereto, characterized in that the axis (x) of the lock cylinder (27) is disposed such that it crosses the axis (12) of the number discs (14).

10. Closure according to one or more of the preceding claims or in particular according thereto, characterized in that the two closure parts (3, 4) can be rotated in relation to one another for opening purposes.

11. Closure according to one or more of the preceding claims or in particular according thereto, characterized in that the regulating shoulder (26′) is disposed at the free end of the catch member (21).
